(19) United States
(12) Patent Application Publication
(10) Pub. No.: US 2019/0114367 A1
(43) Pub. Date: Apr. 18, 2019

(54) EVENTLESS AD DELIVERY

(71) Applicant: Advertise.com, Inc., Sherman Oaks, CA (US)

(72) Inventors: Garrick Andrew Plagge, Hermosa Beach, CA (US); Daniel Yomtobian, Beverly Hills, CA (US)

(21) Appl. No.: 15/782,763

(22) Filed: Oct. 12, 2017

(51) Int. Cl. G06F 17/30; G06Q 30/02; H04L 29/08

(52) U.S. Cl. CPC G06F 17/30905; G06F 17/30873; H04L 67/02; G06Q 30/0277

(57) ABSTRACT

A system and methods for eventless ad delivery to a user of an Internet browser. The method includes receiving in the Internet browser a web page from a publisher, the web page including a script tag and ad delivery code, the script tag including ad delivery parameters. The script tag may be added to the web page by a browser ad extension. Upon the occurrence of a consumer event, the consumer event specified in the ad delivery parameters, the ad delivery code executing and creating a blank Internet browser window not readily viewable by a user of the Internet browser. According to the ad delivery parameters, one or more ads in windows in the Internet browser are created at specified times after the occurrence of the consumer event. According to this method, the consumer will be unaware of the publisher that caused the ad window and related ad to appear.

### NOTICE OF COPYRIGHTS AND TRADE DRESS

This patent document contains material which is subject to copyright protection. This patent document may show and/or describe matter which is or may become trade dress of the owner. The copyright and trade dress owner has no objection to the reproduction by anyone of the patent disclosure as it appears in the Patent and Trademark Office patent files or records, but otherwise reserves all copyright and trade dress rights whatsoever.

### BACKGROUND

### Field

This disclosure relates to Internet ad delivery, and specifically to ads delivered via an Internet browser.

### Description of the Related Art

The Internet is ubiquitous in our society. We all shop for products, read news, search for and interact with service providers, listen to music and watch films via the Internet. This is often done using a web or Internet browser. A consumer of products, news, services, music, and films typically interacts with providers through a web site made available by the provider. In this way, all providers are publishers as they publish web sites.

Many web sites include advertisements or ads. The ads may provide income to the publisher by promoting offerings of others or may promote the publisher's offerings. The ads may be text, graphics, video, or a combination of these. The location of the ads is important because publishers may not want the ad to interfere with their primary purpose or obstruct, hinder or detract from the content on the publisher's web site. Some ads are included on or in web pages, while others are provided in independent browser windows or browser tabs. Some of the independent browser windows may be pop up ads that appear in the foreground of a consumer's screen, obstructing in whole or in part the active browser window. Others are pop under ads that appear behind the currently viewed or active browser window. Yet other ads scroll across, over or through an active browser window, impeding viewing of the content of the active browser window. For this and other reasons, the timing and location of ads is important.

### DESCRIPTION OF THE DRAWINGS

FIG. 1 is a block diagram of an environment in which the eventless ad delivery system and methods described herein is implemented.

FIG. 2 is a flow chart of actions taken according to a method of eventless ad delivery to a user of an Internet browser.

### DETAILED DESCRIPTION

A system and methods to deliver ads to Internet browser users is described herein. The system and methods can be used to deliver ads to a viewer of an Internet web page at a time after the viewer initially visited the Internet web page. Providers of products, news, services, music, and films provide web sites to consumers. In this way, all providers are publishers as they publish web sites. Providers obtain ads to include in their web sites from advertising networks. When a consumer views a publisher's web page, ads are often included in the web page. In addition, ads may be included in additional web browser windows or web browser tabs. The ads may be text, graphics, video, or a combination of these. These are referred to individually and collectively herein as ad content. The ads may be presented in series, a sequence or other sequential grouping. In a series of ads, sequence of ads or other sequential grouping of ads, the ads may all be the same kind of ad content or may be two or more kinds of ad content.

Ads are typically displayed in response to a consumer's specific action referred to as an event, such as clicking on a button or scrolling a web page to a certain location. In current systems, when the event occurs, an ad is presented to the consumer. In current systems, at the occurrence of an event, the consumer perceives that the ad is created by or associated with the particular web page viewed when the event occurs. The eventless ad delivery system described herein changes this well-known paradigm. The eventless ad delivery system presents an advertisement to a consumer in a browser window at a time after the consumer event that triggered the creation of a typical ad. As will be described in more detail below, the eventless ad delivery system causes the presentation of an ad in a browser window to be wholly disassociated with the event that triggered the creation of the ad as well as the publisher that is the source of the ad.

Environment

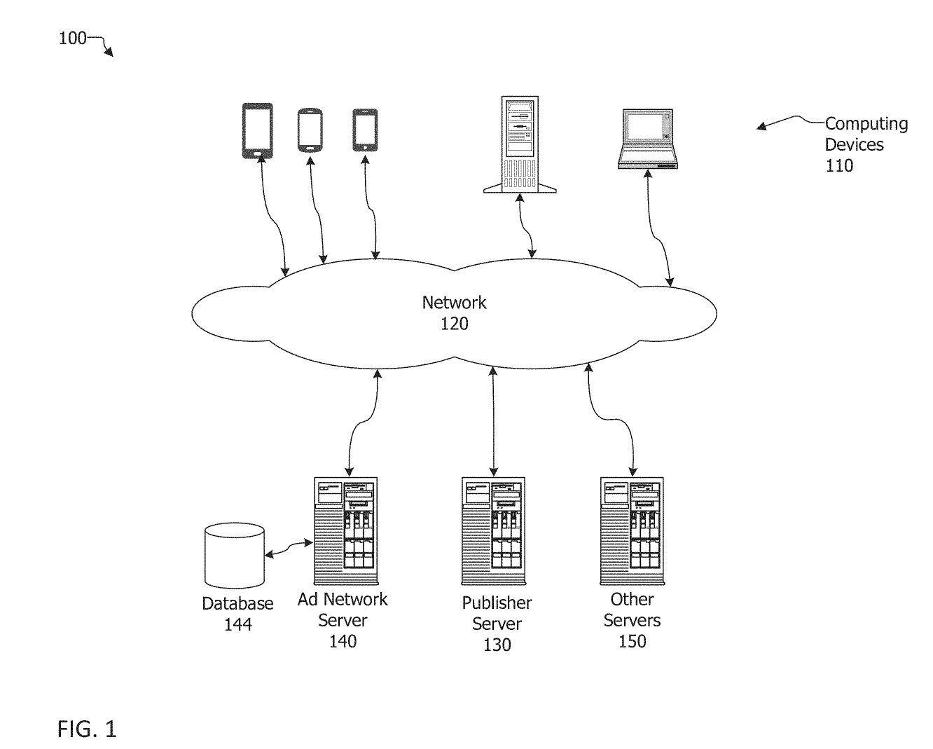

Referring now to FIG. 1 there is shown a block diagram of an environment in which the eventless ad delivery system and methods described herein is implemented. Multiple servers operate in conjunction with consumer computing devices to provide the functionality and features described herein.

The environment includes computing devices 110 used by consumers to access web sites provided by publisher servers 130. Consumers using computing devices 110 connect to publisher web sites served by publisher servers 130. Consumers typically either enter the specific domain name or uniform resource locator (URL) for the publisher's web site or search for a product or service using an Internet search engine, such as, for example, GOOGLE, BING, YAHOO or AOL, which provides multiple links to providers of the specified product or service. When the consumer specifies a URL or clicks on a search result specifying a web page, the publisher server 130 provides the computing device computer code for the web page, including ad software code for ads included in or otherwise associated with the specified web page. The ad software code includes information specifying an ad network server 140 that will provide the ads for the web page. The ad network server 140 may provide the ad content itself or obtain or direct the web page in the consumer's browser to obtain it from one or more other servers 150 such as video servers, graphics servers, image servers, ad content servers and/or ad servers. The ad network server 140 may maintain layout information, accounting information, ad content preferences, and other ad information in one or more databases 144. Although shown in FIG. 1 as single servers, the ad network server 140, the publisher server 130, and the other servers 150 may each be multiple servers which may be at a single location or at multiple locations. The consumer's computing device 110, publisher servers 130, ad network servers 140 and other servers 150 communicate with each other over the Internet shown as network 120.

According to the methods described herein for eventless ad delivery, when an event in a publisher's web page occurs, the ad network server 140 or other server 150 may provide ad content or obtain or direct that ad content is obtained from one or more other servers 150 such as video servers, video ad content network, ad content network, graphics servers, image servers, and/or ad servers and included in a later displayed web browser window. The ad content may be obtained or delivered when the event occurs or shortly after, or the ad content may be obtained or delivered at a later time, such as shortly before being displayed or otherwise provided to the consumer. In either version of the system, the ad content is not displayed or otherwise provided to a consumer until some later time disassociated with the event. The ad content may be one item of ad content or be a series, sequence or other sequential grouping of ad content that is initiated at a time after the event occurred.

A server computer, including publisher servers 130, ad network servers 140 and other servers 150 may include one or more of, for example: logic arrays, memories, analog circuits, digital circuits, software, firmware, and processors such as microprocessors, field programmable gate arrays (FPGAs), application specific integrated circuits (ASICs), programmable logic devices (PLDs) and programmable logic arrays (PLAs). The servers all include one or hardware communications interfaces and related software which may be one or more network interface cards (NICs) or devices that provide for communication over network 120 using Ethernet and other communication protocols. Portions of the methods, functionality and features described herein are embodied in software which operates on the server computers and may be in the form of firmware, an application program, an applet (e.g., a Java applet), JavaScript, Java tags, a browser plug-in, a COM object, a dynamic linked library (DLL), a script, one or more subroutines, or an operating system component or service. The software may maintain a database of information about publishers and consumers. The database may be implemented using the structured query language more commonly known as SQL or MySQL as well as other database software. The hardware and software and their functions may be distributed such that some are performed by one server computer and others by other server computers. The publisher server 130 may, in some embodiments, access the ad network servers 140 and the other servers 150 via URLs, application interfaces (API's), and other techniques. The ad network server 140 may, in some embodiments, access the other servers 150 via URLs, application interfaces (API's), and other techniques.

Along with the publisher servers 130, ad network servers 140 and other servers 150, the processes and methods are implemented in coordination with consumer computing devices 110. The other servers may include sources for ads including other ad network servers, ad content servers, graphics servers, video servers, ad video servers, ad graphics servers, and others. A computing device as used herein refers to any device with a processor, memory and a storage device that executes instructions including, but not limited to, personal computers, server computers, computing tablets, smart phones, portable computers, and laptop computers. These computing devices run an operating system, including, for example, variations of the Linux, Microsoft Windows, Android, and Apple iOS, Mac or macOS operating systems as well as other mobile and desktop operating systems. The computing devices also include one or more, and, typically, multiple, hardware communications interfaces or devices and related software which may be one or more network interface devices that provide for communication over network 120 using Ethernet, cellular telephone, WIFI, and other communication technologies and protocols. The computing devices 110 include or have coupled thereto at least one display and user input devices such as one or more of a touch screen, keys, buttons, keyboards, stylus, track pads, mice, and the like and may support input by voice via microphone, by eye movement recognition, by hand gesture recognition, by body position, as well as others.

The techniques may be implemented in part in software and stored on a machine readable storage medium which may be included in a storage device included with or otherwise coupled or attached to a publisher server 130, an ad network server 140, other servers 150 and a consumer computing device 110. That is, the software may be stored on machine readable storage media. These storage media include magnetic media such as hard disk drives (HDDs); optical media such as compact disks (CD-ROM and CD-RW), digital versatile disks (DVD and DVD±RW) and Blu-ray; silicon media such as solid-state drives (SSDs) and flash memory cards; and other magnetic, optical or silicon storage media. The software may also be stored in volatile silicon or other physical memory such a RAM. As used herein, a storage device is a device that allows for reading from and/or writing to a storage medium. Storage devices include hard disk drives, optical disc drives, SSDs, flash memory devices, and others.

The publisher servers 130, ad network servers 140 and other servers 150 communicate through a network 120 with each other and with consumer computing devices 110 The network 120 comprises one or more public and/or private data networks, and other networks and sub-networks, and may include or be the Internet. The network 120 may also include or access cellular telephone and land line telephone networks. The network 120 includes additional devices, not shown, such as routers, switches, firewalls, multiplexors and other networking equipment that enable and enhance network communications. Additional specialized servers such as application servers, database servers, and others may be coupled with or included with the publisher servers 130, ad network servers 140 and other servers 150.

Description of Processes

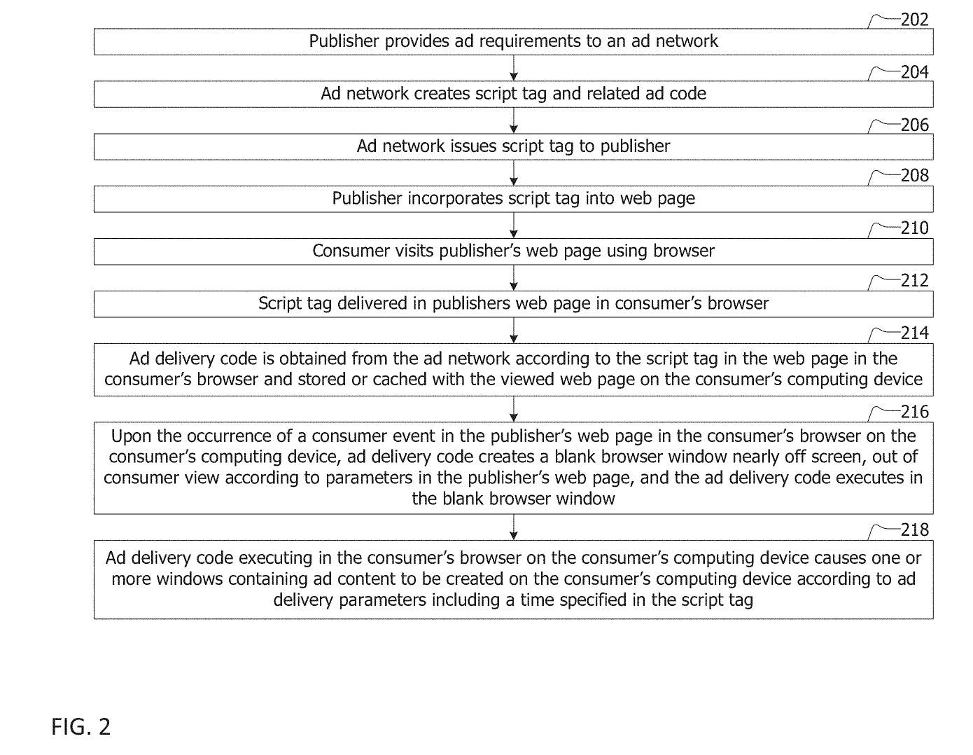

Referring now to FIG. 2 there is shown a flow chart of actions taken according to a method of eventless ad delivery. A publisher specifies requirements for an ad and sends or otherwise provides the requirements to an ad network, as shown in block 202. The requirements include, for example: one or more of, a kind or category of the subject of the ad, such as clothing, consumer goods, kids toys, automobile related, as well as ad network, run of network, ad channel specification, and others; a kind or category of the media in the ad, such as video, graphics, etc.; a delay or time, namely how long after the occurrence of a consumer event the ad should be displayed; an ad display kind or type, such as, in a pop under window, pop over window, slide over, and windows in various positions on the screen; a designation of resulting window handle, focus or active point on the screen, namely whether the cursor or focus will remain at the location it was in prior to the ad window being displayed or if the cursor or focus will move to within the ad window; a size or dimensions of the window to be created, typically in pixels or dots; and others. The ad network creates a script tag, as shown in block 204. The script tag includes key parameters for the display of an ad according to this method.

The following are the fields that may be included in a script tag. Many of the parameters are optional. When no values are specified for a parameter, system default actions will occur. Depending on the implementation, system default actions may be, for example, to create a pop under window 2 hours after a consumer event, where the consumer event is clicking on a link; to create a pop under window 90 minutes after a consumer event, where the consumer event is hovering over an image; etc. The script tag parameters and kind of values for the parameters, followed by a description of the parameter are provided below.

1. Event: This parameter is a text field that described a consumer event, which may be scroll, scroll up, scroll down, click, doubleclick, mousedown, mouseup, scrollup, scrolldown, hover, gesture recognition, and others. This field is optional. When this field is not specified, a system default value is used, such as, for example, click or scroll, or other value based on business requirements of the publisher.

2. Affiliate: This parameter is a name or code for an affiliate. It is an alpha-numeric string or may be a numeric identifier. This field is required.

3. Subscriber ID or subid: This parameter is a subscriber identifier. It is an alpha-numeric string or may be a numerical identifier. This field is optional.

4. AdCountIntervalHours: This parameter is an integer representing the number of hours to sleep and not show ads after all ads have been displayed. In one embodiment, this is an integer between 1 and 48. Other maximum and minimum values may be supported. This allows an ad window or sequence of ad windows to be created on an ongoing basis at the interval specified. This field is optional. When this field is not specified, a system default value is used, such as, for example, 8, 12, 18, 24, 48, or other value based on business requirements publisher.

5. Entry: This parameter is a text description of the kind of entry the ad window will make. The parameter values for this are text strings that represent the entry action. This can be considered an entry animation. The parameter values include popunder, poup, slidein, fromtop, frombottom, fromside, and others. This field is optional. When this field is not specified, a system default value is used, such as, for example, popunder, or other value based on business requirements of the publisher.

6. Height: This parameter is an integer value in pixels of the height of the ad window to be created. The values may be, for example, from 240 to 2056. Depending on the implementation, other maximum and minim values may be used. If no height is specified, the system may create ad windows of a default height, such as 800, or other value based on business requirements of the publisher.

7. Width: this is an integer value in pixels of the width of the ad window to be created. The values may be, for example, from 240 to 2056. Depending on the implementation, other maximum and minim values may be used. If no width is specified, the system may create ad windows of a default width, such as 600, or other value based on business requirements of the publisher.

8. ADcount: ADcount or count is an integer N which specifies the number of ad windows to be created. Currently, the valid range used is from 1 to 5, but, in other embodiments, the number could be larger such as 8, 12 or more. In one embodiment, if the ADcount parameter is not specified, one add will be displayed. In other embodiments, system default numbers of ads may be displayed if the ADcount parameter is missing or not used.

9. ADdelay1, ADdelay2, ADdelay3 . . . ADdelayN: An ADdelay or delay is specified for each ad that will be displayed corresponding to the ADcount value. In one embodiment, the delay values are in minutes, such a 1 for 1 minute, 2 for 2 minutes, 60 for 60 minutes corresponding to 1 hour, 120 for 120 minutes corresponding to 2 hours, 1440 minutes corresponding to 1 day, 2880 minutes corresponding to 2 days, etc. In one embodiment, the maximum delay is 10,080 minutes corresponding to 1 week. Other delay maximums may be set or configured depending on the implementation. Further, although described here in minutes, the delay value could specify seconds or hours depending on the implementation. In some embodiments, if no ADdelay is specified, a system default algorithmic delay, rotating sequence of delays, user activity based delay, page content based delay, page size based delay or random delay may be used before the ad is displayed. For example, in one embodiment, according to a system default, an ad will be displayed 3 hours after the occurrents of a consumer event. Other system default values may be used, including, for example, 90 minutes, 2 hours, 3 hours, 8 hours, 12, hours, 1 day, 2 days, and numbers, times in between.

10. ADsnooze: The ADsnooze or snooze parameter is an integer that specifies the number of half-lives until a repeat attempt to display the ad window is attempted when a failure is detected or sensed. In one embodiment, when the number is 0, no additional time is added. In one embodiment, when a system specified flag or key number is specified such as 10 or 33 or 99, a check may be made to determine if a consumer has not left the website that was the source of the script tag, and then wait longer than the initial delay. In one embodiment, a check if the window where the consumer event occurred is closed may be made, and, if not closed, wait another ADsnooze number of half-lives of the ADdelay above. In this way, ad delivery is product consumption aware. This may allow for a check to confirm that a consumer has completed reading an article or answering a survey or other possibly long activity before beginning the ADdelay. That is, the system may wait an ADsnooze half-life of the ADdelay before starting the ADdelay count when a consumer has not left the web page where the consumer event occurred. This field is optional. When this field is not specified, a system default value is used, such as, for example, 10, 200, 1,000, 10,000 or other value based on business requirements of the publisher.

The following is an example script tag, provided in an easy readable format.

<script

src=“http://www.domain.com/path/program.do?
event=click&
affiliate=aff&
adCountIntervalHours=24&
maxAdCountsPerInterval=0&
entry=popunder&
attributionDisabled=true&
ADcount=3&
ADdelay1=10&
ADdelay2=60&
ADdelay3=120&
ADsnooze=2&
type=“text/javascript”>

</script>

The script tag shown above is delivered in web page code and looks like this. <script src=“http://www.domain.com/path/program.do?event=click&affiliate=aff&subid=sub&adCountIntervalHours=24&entry=popunder&ADcount=3&ADdelayl=10&ADdelay2=60&ADdelay3=120&ADsnooze=2&type=”text/javascript“></script>

The script tag parameters described above have names that are provided for convenience. The names provided herein are only example parameter names. Other names for the parameters may be used.

The script tag specifies parameters that are used to configure ad display parameters used in ad display code that is distributed with the publisher's web page as described in more detail below.

Returning to a discussion of FIG. 2, in one embodiment, the ad network issues (or sends) the script tag to the publisher, as shown in block 206. To achieve this, in practice, the script tag may be emailed from the ad network to the publisher. Further, the ad network may provide the script tag to a publisher via an ad management portal or web page such that the script tag may be downloaded by a publisher via the ad network ad management portal or web page. In one embodiment, the publisher incorporates the script tag in a web page, as shown in block 208. In another embodiment, ad network delivers the script tag to an extension in the consumer's web browser, and the browser extension inserts the script tag into a publisher's web page. In this embodiment, the ad network also delivers the browser extension to the consumer. The browser extension may be considered an add-on or plug in. The consumer may download a browser extension to add a feature to the browser or provide a service to the browser that is desirable to the user. In exchange, ads will be provided to the consumer. To create the ads, the browser extension augments web pages visited by the user with a script tag; that is, the browser extension places a script tag into the web pages the consumer visits. When the browser executes or renders the web page, the script tag is processed as if the web page had the script tag included in it upon receipt.

A consumer visits the publishers web page using a browser on a computing device, as shown in block 210. As the script tag is included in the software code for the publisher's web page, the script tag is delivered, communicated from the publisher to the consumer, included in publisher's web page in the consumer's browser, as shown in block 212. In another embodiment, a browser extension included in the browser augments web pages visited by the user with a script tag; that is, the browser extension places a script tag into web pages the consumer visits. Ad delivery code is obtained from the ad network according to the script tag in the web page in the consumer's browser and may be stored or cached with the viewed web page on the consumer's computing device, as shown in block 214. In one embodiment, the ad delivery code may be stored in secure browser cache memory to allow for fast reloads of the ad delivery code. The ad delivery code is, in one embodiment, Javascript code.

Upon the occurrence of a consumer event in the publisher's web page in the consumer's browser on the consumer's computing device, ad delivery code creates a blank bowser window not readily viewable by the consumer, out of consumer view according to parameters in the publisher's web page. The blank browser window may be nearly off screen. In one embodiment, only a few pixels or a small number of columns or rows of pixels may be on screen such that the blank browser window is mostly off screen. The ad delivery code and optional user interface executes in the blank browser window, as shown in block 216. The blank browser window is created according to “about blank” rules. The “about blank” rules refer to the about:blank construct defined in Internet Engineering Task Force, Request for Comment (IETF RFC) 6694. RFC 6694 specifies how Internet browsers will support the creation of a blank page using about:blank.

In one embodiment, the consumer event is a single event such as a mouse down or hover over a graphical user interface element such as a graphic or text area in the publisher's web page. Other consumer events or actions, or a sequence of two or more consumer events may cause the ad delivery code to execute, such as double click, double tap, finger down and finger up, finger down, mouse down, mouse down and up, consumer eye movement recognition, consumer gesture recognition, consumer voice recognition, other sound recognition, and others. The kind of consumer event trigger is specified in the web page code. An ad is not displayed to or made available to a consumer at the time of the consumer event. Rather, the consumer event causes the ad delivery code to execute in the browser on the consumer's computing device.

After a period of time specified in ad delivery parameters in the ad delivery code, one or more windows containing one or more ads are created and made accessible to the consumer. More specifically, the ad delivery code executing in the consumer's browser on the consumer's computing device causes one or more windows containing ad content to be created on the consumer's computing device according to the ad delivery parameters including a time specified in the script tag as shown in block 218. The ad delivery parameters are derived from or include the parameters included in the script tag described above. In one embodiment, if no time is specified, a system default time is used. In one embodiment, a pop under window showing an ad is created by the ad delivery code according to the ad delivery parameters including a time and a location on the consumer's computing device specified in the script tag. In this way, the ad is not associated with the consumer event or publisher's page responsible for the ad as the ad is displayed on the consumer computing device and discovered or perceived by the consumer a specified period after the web page in which the script tag was included was accessed and/or viewed. That is, there is no consumer correlation between the publisher that triggered or caused the ad to be displayed and the ad itself. The length of delay between initial activation of the ad delivery code by a consumer event may be minutes, hours or even days. In this way, an ad is presented to a consumer by the publisher long after the consumer has performed an activity on the publisher's web page that initiated the execution of the ad delivery code. The windows created with the ads may be pop unders, pop overs, slide ins, and others, and may contain text, graphics, video, or a combination of these including links to website promoting products and services. Further, although the term ad is used for convenience in this paragraph, the term ad refers to ad content that may be a series of ads, sequence of ads or other sequential grouping of ads and may be or include one or more of text, graphics, video and a combination of these.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. Regarding flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for eventless ad delivery via an Internet browser comprising:
receiving in the Internet browser a web page from a publisher, the web page including a script tag, the script tag including ad delivery parameters, the web page causing the Internet browser to download ad delivery code
upon the occurrence of a consumer event, the consumer event specified in the ad delivery parameters, the ad delivery code executing and creating a blank Internet browser window not readily viewable by a user of the Internet browser
creating according to the ad delivery parameters, one or more ads in windows in the Internet browser at specified times after the occurrence of the consumer event.

2. The method of claim 1 wherein the ad delivery parameters include a number of ad windows and a delay for each of the ad windows, the delay specifying a time period after the occurrence of a consumer event that the ad window will be created.

3. The method of claim 2 wherein the ad delivery parameters further include a retry value which specifies a retry time period after which a failed attempt at creating a corresponding ad window will be reattempted.

4. The method of claim 2 wherein the ad delivery parameters further include ad window parameters for each window specifying window dimensions and a kind of window entry.

5. The method of claim 4 wherein the kind of window entry is one selected from the group including pop under, pop over, slide in.

6. The method of claim 1 wherein the creating the windows includes creating windows at locations specified in the ad delivery parameters

7. The method of claim 1 wherein the creating the windows includes creating windows in system default locations.

8. The method of claim 1 wherein the blank Internet browser window is mostly off screen.

9. The method of claim 1 wherein the consumer event is a consumer interaction with a graphical user interface element in the web page, the consumer event is one selected from the group including a mouse down, a mouse up, a hover over, double click, double tap, finger up, finger down and finger up, finger down, voice recognition, eye movement recognition, user gesture recognition, mouse down and mouse up.

10. The method of claim 1 wherein the blank Internet browser window is created according to an about:blank command.

11. The method of claim 1 wherein the Internet browser is one selected from the group including a version of the Chrome browser, Safari browser, Firefox browser, Edge browser and Opera browser.

12. A method for eventless ad delivery via an Internet browser comprising:
receiving in the Internet browser a web page from a publisher
a browser extension included with the Internet browser augmenting the web page with a script tag to create an augmented web page, the script tag including ad delivery parameters
the Internet browser rendering the augmented web page causing the Internet browser to download ad delivery code
upon the occurrence of a consumer event, the consumer event specified in the ad delivery parameters, the ad delivery code executing and creating a blank Internet browser window not readily viewable by a user of the Internet browser
creating according to the ad delivery parameters, one or more ads in windows in the Internet browser at specified times after the occurrence of the consumer event.

13. The method of claim 12 wherein the ad delivery parameters include a number of ad windows and a delay for each of the ad windows, the delay specifying a time period after the occurrence of a consumer event that the ad window will be created.

14. The method of claim 13 wherein the ad delivery parameters further include a retry value which specifies a retry time period after which a failed attempt at creating a corresponding ad window will be reattempted.

15. The method of claim 13 wherein the ad delivery parameters further include ad window parameters for each window specifying window dimensions and a kind of window entry.

16. The method of claim 15 wherein the kind of window entry is one selected from the group including pop under, pop over, slide in.

17. The method of claim 12 wherein the creating the windows includes creating windows at locations specified in the ad delivery parameters

18. The method of claim 12 wherein the creating the windows includes creating windows in system default locations.

19. The method of claim 12 wherein the blank Internet browser window is mostly off screen.

20. The method of claim 12 wherein the consumer event is a consumer interaction with a graphical user interface element in the web page, the consumer event is one selected from the group including a mouse down, a mouse up, a hover over, double click, double tap, finger up, finger down and finger up, finger down, voice recognition, eye movement recognition, user gesture recognition, mouse down and mouse up.

21. The method of claim 12 wherein the blank Internet browser is created according to an about:blank command.

22. The method of claim 12 wherein the Internet browser is one selected from the group including a version of the Chrome browser, Safari browser, Firefox browser, Edge browser and Opera browser.
